(19) United States
(12) Patent Application Publication
(10) Pub. No.: US 2015/0279237 A1
(43) Pub. Date: Oct. 1, 2015

(54) CARDIAC MASSAGE PRACTICE DEVICE AND CARDIAC MASSAGE PRACTICE METHOD

(71) Applicant: TOHO UNIVERSITY, Ota-Ku (JP)

(72) Inventors: Atsushi SUGIYAMA, Tokyo (JP); Keith G. Lurie, Minneapolis, MN (US)

(73) Assignee: TOHO UNIVERSITY, Ota-ku (JP)

(21) Appl. No.: 14/229,549

(22) Filed: Mar. 28, 2014

(51) Int. Cl. G09B 23/28

(52) U.S. Cl. CPC G09B 23/288

(57) ABSTRACT

A cardiac massage practice device including a simulated heart, a simulated vein, a simulated artery, and a mannequin of an upper half of a human body, wherein the simulated heart contracts from a stationary state to be deformable to a contracted state, and dilates from the stationary state to be deformable to a dilated state, wherein the simulated vein is coupled to the simulated heart, and when the simulated heart dilates from the contracted state, transfers virtual blood to an inside of the simulated heart, wherein the simulated artery is coupled to the simulated heart, and when the simulated heart contracts from the dilated state, transfers the virtual blood transferred to the inside of the simulated heart from the inside of the simulated heart to an outside of the simulated heart, and wherein the mannequin of the upper half of the human body houses the simulated heart therein.

### BACKGROUND OF THE INVENTION

1. Field of the Invention

The present invention relates to a cardiac massage practice device used in practice of cardiac massage and a cardiac massage practice method using the same.

2. Description of the Related Art

Conventionally, practice devices and practice methods for training of cardiac massage by cardiopulmonary resuscitation have been proposed.

For example, practice devices made with a mannequin of a whole or upper-half body simulating a human body are commercially available (see, for example, the HP of Avice, Inc., Ltd. on the Internet: <URL; http://humanbody.jp/simulator/item/w44001.html> and the HP of Nihon 3B Scientific, Inc., Ltd. on the Internet: <URL; http://www.3bs.jp/simulator/aed/w19633.htm>). These practice devices are configured such that whether skills of a person who is performing cardiac massage are proper or improper can be judged from indication of a lamp or sound. For example, the lamp is set to show “green” when compression is proper, “orange” when compression is too strong, or “red” when the position of compression is incorrect; or clicking sound is set to generate when compression is performed at an appropriate position of compression.

In the cardiopulmonary resuscitation, what is the most important is how much blood can be transferred from the heart by cardiac massage. However, the above practice devices conventionally used have serious problems or drawbacks that it is not possible at all to know the amount of blood that has been able to be transferred from the heart by cardiac massage. The conventional practice devices totally lack an essential point of view that training of cardiac massage should be performed by using as an indication the amount of blood that has been able to be transferred from the heart by cardiac massage.

Meanwhile, several compact practice devices for cardiac massage have been proposed (see, for example, International Publication No. WO2010/147129). These compact practice devices can be used as an educational material for learning the movement of the heart by cardiac massage and the principles of the cardiopulmonary resuscitation. However, they are totally different structures from an actual human body and thus have a fundamental problem that they cannot provide an alternative to training of actually compressing the chest. And, needless to say, these compact practice devices have serious problems or drawbacks that they take no account of the amount of blood that has been able to be transferred from the heart by cardiac massage.

On the other hand, as an assist device used in cardiac massage by the cardiopulmonary resuscitation, a manual heart pump (see, for example, “CARDIO PUMP” sold by IMI Corporation, Ltd., the HP of this company on the Internet: <URL; http://www.info.pmda.go.jp/ygo/pack/20500BZY00126000>) and an ITD-equipped resuscitation kit which is mounted on the mouth to control flow of air into the lungs during chest decompression (see, for example, “RESQPOD (registered trademark)”, medical device admission number: 22300BZX00315000, manufactured by U.S. Scientific Molding Corporation Ltd., the HP of this company on the Internet: <URL; http://www.nihonkohden.co.jp/iryo/products/resp_resus/02_def/resqpod.html>) are commercially available. These are useful assist devices in cardiac massage by the cardiopulmonary resuscitation. However, when the conventional practice devices for cardiac massage are used, there is a problem that it is not possible to conveniently judge whether the performance of these assist devices in use is good or poor.

The present invention aims to solve the above conventional problems and achieve the following object. That is, an object of the present invention is to provide a cardiac massage practice device and a cardiac massage practice method, with which cardiac massage by the cardiopulmonary resuscitation can be realistically practiced in a state close to the actual state using a mannequin simulating a human body, anyone who is not an expert can easily and conveniently know the amount of blood that has been able to be transferred from the heart by cardiac massage, whether skills of cardiac massage are good or poor can be easily judged by using this amount of blood transferred as an indicator, and whether the performance of assist devices such as a manual pump in use is good or poor can also be judged properly and easily.

### SUMMARY OF THE INVENTION

A cardiac massage practice device of the present invention includes: a simulated heart; a simulated vein; a simulated artery; and a mannequin of an upper half of a human body,

wherein the simulated heart contracts from a stationary state to be deformable to a contracted state, and dilates from the stationary state to be deformable to a dilated state,

wherein the simulated vein is coupled to the simulated heart, and when the simulated heart dilates from the contracted state, the simulated vein transfers virtual blood to an inside of the simulated heart,

wherein the simulated artery is coupled to the simulated heart, and when the simulated heart contracts from the dilated state, the simulated artery transfers the virtual blood transferred to the inside of the simulated heart from the inside of the simulated heart to an outside of the simulated heart, and

wherein the mannequin of the upper half of the human body houses the simulated heart therein.

A cardiac massage practice method of the present invention is a method of performing cardiac massage using a cardiac massage practice device which is formed to have a shape of a mannequin of an upper half of a human body, the method including:

a cardiac massage step of compressing at regular intervals a surface of a chest corresponding to a position of a heart in the cardiac massage practice device, and

a transferred virtual blood amount-measuring step of measuring an amount of virtual blood transferred from the cardiac massage practice device per unit time of a time for which the cardiac massage step is performed,

wherein the cardiac massage practice device is the above cardiac massage practice device of the present invention.

### BRIEF DESCRIPTION OF THE DRAWINGS

FIG. 1 is a schematic plan view of one example of the cardiac massage practice device of the present invention.

FIG. 2A illustrates the cardiac massage practice device of FIG. 1 with the head removed, and is a schematic plan view for explaining arrangement of the simulated heart, the simulated vein and the simulated artery in the cardiac massage practice device.

FIG. 2B is a schematic side view illustrating the cardiac massage practice device of FIG. 2A from a side of the cardiac massage practice device.

FIG. 3 is a schematic explanatory view of one example of the simulated heart in the present invention.

FIG. 4 is a schematic explanatory view illustrating a state where the simulated heart of FIG. 3 is disassembled into a hollow elastic body and a valve-containing member.

FIG. 5 is a schematic explanatory view illustrating a simulated mitral valve disposed in the valve-containing member of FIG. 4 from a side of the hollow elastic body (from the inside of the simulated heart).

FIG. 6 is a schematic explanatory view illustrating a simulated mitral valve disposed in the valve-containing member of FIG. 4 from a side where the simulated vein is to be coupled (from the inside of the simulated vein).

FIG. 7 is a schematic explanatory view illustrating a simulated aortic valve disposed in the valve-containing member of FIG. 4 from a side where the simulated artery is to be coupled (from the inside of the simulated artery).

FIG. 8A is a schematic explanatory view for explaining movements of the simulated mitral valve and the simulated aortic valve and flow of virtual blood when the simulated heart is in diastole.

FIG. 8B is an echocardiogram corresponding to FIG. 8A for explaining movements of the mitral valve and the aortic valve and flow of blood in the actual heart in diastole.

FIG. 8C is a schematic explanatory view for explaining movements of the simulated mitral valve and the simulated aortic valve and flow of virtual blood when the simulated heart is in systole.

FIG. 8D is an echocardiogram corresponding to FIG. 8C for explaining movements of the mitral valve and the aortic valve and flow of blood in the actual heart in systole.

FIG. 9 is a schematic explanatory view for explaining a state where cardiac massage is performed using “CARDIO PUMP” sold by IMI Corporation, Ltd., which is a commercially available assist device for cardiac massage.

### DETAILED DESCRIPTION OF THE INVENTION

### (Heart Massage Practice Device and Heart Massage Practice Method)

A cardiac massage practice device of the present invention includes a simulated heart, a simulated vein, a simulated artery, and a mannequin of an upper half of a human body, and may further include other members appropriately selected if necessary.

A cardiac massage practice method of the present invention includes a cardiac massage step and a transferred virtual blood amount-measuring step, and may further include other steps appropriately selected if necessary. The cardiac massage practice method of the present invention can be suitably performed by the cardiac massage practice device of the present invention.

Hereinafter, the cardiac massage practice device of the present invention will be explained, and by way of explanations of its use and principles, the cardiac massage practice method of the present invention will also be explained.

—Simulated Heart—

The simulated heart is not particularly limited and may be appropriately selected depending on the intended purpose so long as it has functions of contracting from a stationary state to be deformable to a contracted state, and dilating from the stationary state to be deformable to a dilated state.

Suitable specific examples of the simulated heart include one including a hollow elastic body, a simulated mitral valve, and a simulated aortic valve. The simulated heart may further include other members appropriately selected if necessary.

The hollow elastic body may be appropriately selected from known products so long as it has a hollow structure provided with an inner space therein and has elasticity to enable deformation of contraction or dilation. Since the hollow elastic body has such elasticity, it can have a form of being contracted (compressed) compared to its stationary state when externally compressed (pressurized), and conversely can have a form of being dilated (expanded) compared to its stationary state when externally aspirated (vacuumed).

Elastic deformation of the hollow elastic body needs to occur in response to operations of chest compression during practice of cardiac massage. In a state where the hollow elastic body is provided in the mannequin of the upper half of the human body, its elastic deformation may occur at least when operations of chest compression have been done to the mannequin of the upper half of the human body, but more preferably it occurs in all directions around the hollow elastic body.

A material of the hollow elastic body is not particularly limited and may be appropriately selected depending on the intended purpose so long as the hollow elastic body causes the elastic deformation during practice of cardiac massage. Examples of the material of the hollow elastic body include resins, rubber, and elastomers, known per se. Examples of the resins include thermoplastic resins. Suitable examples of the thermoplastic resins include general-purpose resins. Examples of the general-purpose resins include polyolefins, polyesters, polyvinyl chlorides, polystyrenes, and polycarbonates. Examples of the polyolefins include polyethylenes and polypropylenes. Examples of the polyesters include polyethylene terephthalates and polybutylene terephthalates. These resins may contain a plasticizer. Examples of the rubber include natural rubber and synthetic rubber. Examples of the synthetic rubber include SBR rubber. Examples of the elastomers include thermoplastic elastomers. These may be used alone or in combination of two more of them.

The inner space (chamber) in the hollow elastic body is assumed to be the same as the heart's inner space in the heart of a human body; i.e., the right atrium, the right ventricle, the left atrium, and the left ventricle. Hence, in the present invention, the volume of the inner space in the hollow elastic body is preferably closer to that of the heart's inner space, but is not limited to this preferable case.

The number of inner spaces (chambers) in the hollow elastic body is not particularly limited and may be appropriately selected depending on the intended purpose. From the viewpoint of realistically simulating the actual heart, it is preferably “4” corresponding to the right atrium, the right ventricle, the left atrium, and the left ventricle. However, in the actual heart, the right atrium, the right ventricle, the left atrium, and the left ventricle are in communication with each other via valves and thus these can also be regarded as “1” space. In this case, since the left ventricle has the most important function in pumping out blood from the heart to the aorta and also influences blood pressure, the number of the inner spaces may be “1” corresponding to the left ventricle.

The structure of the hollow elastic body may be formed with a single member, or two or more members. For example, from the viewpoint of allowing the simulated mitral valve and the simulated aortic valve to sufficiently function as check valves, it is preferable to form these valves of relatively hard materials. Alternatively, portions to be provided with the valves may be formed of a relatively hard material, and the other portion; i.e., the main body, may be formed of a soft material. In this case, the hollow elastic body can be formed to have a structure in which the portions to be provided with the valves and the main body are formed with separate members.

The simulated mitral valve is not particularly limited so long as it has the following functions: when the hollow elastic body dilates from the contracted state to deform to the dilated state, the simulated mitral valve opens and enables the virtual blood to be transferred from the simulated vein to an inside of the hollow elastic body and when the hollow elastic body contracts from the dilated state to deform to the contracted state, the simulated mitral valve closes and prevents backward flow of the virtual blood transferred to the inside of the hollow elastic body to the simulated vein. The size, shape, structure, and material of the simulated mitral valve may be selected depending on the intended purpose. Examples of the simulated mitral valve include known products such as a check valve designed to be rotatable within 90° in only one direction.

The simulated mitral valve is provided in a coupling portion of the hollow elastic body to the simulated vein.

The simulated aortic valve is not particularly limited so long as it has the following functions: when the hollow elastic body contracts from the dilated state to deform to the contracted state, the simulated aortic valve opens and enables the virtual blood to be transferred from the inside of the hollow elastic body into the simulated artery and when the hollow elastic body dilates from the contracted state to deform to the dilated state, the simulated aortic valve closes and prevents backward flow of the virtual blood transferred to the simulated artery to the inside of the hollow elastic body. The size, shape, structure, and material of the simulated aortic valve may be selected depending on the intended purpose. Examples of the simulated aortic valve include known products such as a check valve designed to be rotatable within 90° in only one direction.

The simulated aortic valve is provided in a coupling portion of the hollow elastic body to the simulated artery.

### —Simulated Vein—

The simulated vein is not particularly limited so long as it has the following functions: when the simulated heart dilates from the contracted state, the simulated vein transfers the virtual blood to the inside of the simulated heart. The size, shape, structure, and material of the simulated vein may be selected depending on the intended purpose. Specific examples of the simulated vein include a tubular structure with both ends open. Suitable examples of the simulated vein include a tube formed of a resin or rubber.

An opening of one end of the simulated vein is coupled to the simulated heart so that the virtual blood can flow without leakage. In the present invention, the opening of the other end of the simulated vein coupled to the simulated heart; i.e., the other end opposite to the one end coupled to the simulated heart so that the virtual blood can flow, is preferably extended to the outside of the mannequin of the upper half of the human body. In this case, the simulated vein turns out to be exposed to the outside from the inside of the mannequin of the upper half of the human body, which is preferable since inflow of the virtual blood into the simulated vein can be easily visually observed.

### —Simulated Artery—

The simulated artery is not particularly limited so long as it has the following functions: when the simulated heart contracts from the dilated state, the simulated artery transfers the virtual blood transferred to the inside of the simulated heart from the inside of the simulated heart to the outside of the simulated heart. The size, shape, structure, and material of the simulated artery may be selected depending on the intended purpose. Specific examples of the simulated artery include a tubular structure with both ends open. Suitable examples of the simulated artery include a tube formed of a resin or rubber.

An opening of one end of the simulated artery is coupled to the simulated heart so that the virtual blood can flow without leakage. In the present invention, the opening of the other end of the simulated artery coupled to the simulated heart; i.e., the other end opposite to the one end coupled to the simulated heart so that the virtual blood can flow, is preferably extended to the outside of the mannequin of the upper half of the human body. In this case, the simulated artery turns out to be exposed to the outside from the inside of the mannequin of the upper half of the human body, which is preferable since outflow of the virtual blood from the simulated artery can be easily visually observed.

### —Mannequin of Upper Half of Human Body—

The mannequin of the upper half of the human body is not particularly limited and may be appropriately selected depending on the intended purpose so long as its shape is a mannequin simulating an upper half of a human body, its chest can deform by compression when it is compressed during practice of cardiac massage and can return to the original state when the compression force is released; i.e., can deform to the same extent as the actual chest of a human, and the mannequin can house the simulated heart therein. Specific suitable examples of the mannequin of the upper half of the human body include commercially available mannequins for practice of cardiac massage. These commercially available products are not provided with the simulated heart, the simulated vein, or the simulated artery. However, if spaces for the simulated heart, the simulated vein, and the simulated artery can be secured, it is possible in the present invention to suitably use these commercially available products as the mannequin of the upper half of the human body.

A front face portion in the mannequin of the upper half of the human body where the chest is present preferably has a shape simulating a human body from the viewpoint of realistically practicing cardiac massage. Meanwhile, a back face portion in the mannequin of the upper half of the human body may have a shape simulating the back of a human body, or may be a flat plate.

The mannequin of the upper half of the human body preferably has a simulated skin covering a surface thereof, and a simulated rib inside the simulated skin. When the mannequin of the upper half of the human body has the simulated skin and the simulated rib, a sense of chest compression during practice of cardiac massage can be obtained as a sense approximate to the performance in an actual human body, which is preferable. In addition, when a force of chest compression is too strong, the simulated rib will be broken to give similar effects to fracture of the ribs in an actual human body, which is also preferable.

The simulated skin is preferably formed of a material having elasticity like the skin of a human, rather than a hard material which will be broken. For example, a sheet-form object formed of a soft resin is preferable. Examples of the soft resin include general-purpose resins to which a plasticizer has been added, and suitable examples of the soft resin include polyvinyl chlorides, polyethylenes, polypropylenes, and silicone resins. Note that, the sheet-form object formed of the soft resin has hardness with which it will not be broken even when folded.

The simulated skin may be colorless or colored. When the simulated skin is colorless, the inside underlying the simulated skin can be visually observed, which is preferable. When the simulated skin is colored, for example, the simulated skin having a color of the skin can give a sense of practicing using an actual human, which is preferable. Note that, the simulated skin may be transparent, semi-transparent, or non-transparent.

When the front face portion in the mannequin of the upper half of the human body where the chest is present has a shape simulating a human body, the simulated skin is preferably disposed to cover a surface of the front face portion so as to contour a shape of the front face portion simulating a human body. Also, when the back face portion in the mannequin of the upper half of the human body is the flat plate, the simulated skin can be fixed to the flat plate.

The simulated rib is preferably formed of a hard material which will be broken when a strong compression force is applied. For example, a plate-form object formed of a hard resin is preferable. Examples of the hard resin include general-purpose resins, and suitable examples of the hard resin include polyvinyl chlorides, polyethylenes, polypropylenes, polystyrenes, polycarbonates, and polyesters. Note that, the plate-form object formed of the hard resin has hardness with which it will be broken when folded.

The simulated rib may be colorless or colored. When the simulated rib is colorless, the inside underlying the simulated rib can be visually observed, which is preferable. When the simulated rib is colored, for example, the simulated rib having a color of the skin can give a sense of practicing using an actual human, which is preferable. Note that, the simulated rib may be transparent, semi-transparent, or non-transparent.

When the back face portion in the mannequin of the upper half of the human body is the flat plate, the simulated rib is fixed on the flat plate in a stacked state. It is preferable that the simulated rib be disposed at a side of the lower abdomen such that they are curved from the back side to the front side in the mannequin of the upper half of the human body so as to cover the vicinity of the chest of the mannequin of the upper half of the human body.

### —Other Members—

The other members are not particularly limited and may be appropriately selected depending on the intended purpose. Examples of the other members include a virtual blood container, a liquid amount-measuring container, and simulated organs.

The virtual blood container is not particularly limited so long as it can contain the virtual blood. The size, shape, structure, material, and the like of the virtual blood container may be appropriately selected. Specific examples of the virtual blood container include known buckets, tubs, and bottles. When the simulated vein is connected to the virtual blood container containing the virtual blood, it is possible during practice of cardiac massage to visually observe the virtual blood flowing from the virtual blood container toward the simulated vein. Also, a time of one round of practice of cardiac massage can be adjusted by adjusting the amount of the virtual blood to be contained in the virtual blood container.

Note that, the connection between the virtual blood container and the simulated vein may be made in an open system or a closed system.

The liquid amount-measuring container is not particularly limited so long as it can measure an amount of the virtual blood transferred from the simulated heart via the simulated artery. The size, shape, structure, material, and the like of the liquid amount-measuring container may be appropriately selected. Specific examples of the liquid amount-measuring container include scaled containers (e.g., scaled buckets and scaled bottles), combinations of weighing devices and containers (e.g., buckets and bottles) disposed on the weighing devices, and containers having a weighing function. When the simulated artery is connected to the liquid amount-measuring container, it becomes possible to easily calculate an amount of the virtual blood transferred per unit time of a time for which practice of cardiac massage is performed, which makes it easier to judge whether skills of cardiac massage are good or poor.

Note that, the connection between the liquid amount-measuring container and the simulated artery may be made in an open system or a closed system.

The simulated organs are not particularly limited and may be appropriately selected depending on the intended purpose so long as they are models simulating organs such as the lungs, the stomach, and the liver. From the viewpoint of more realistically realizing movements of contraction and dilation in the chest by chest compression during cardiac massage, suitable examples of the simulated organs include simulated lungs simulating the lungs and a simulated airway simulating the airway. These simulated organs are preferably formed of, for example, a soft resin, rubber, or an elastomer, and examples of the soft resin include polyolefins, polyvinyl chlorides, silicone resins, and polyurethans.

When the simulated lungs are disposed as the simulated organs in the mannequin of the upper half of the human body, it is preferable to form the simulated lungs to be hollow such that air flows into or out of the simulated lungs in response to contraction or dilation of the simulated lungs. Furthermore, it is preferable to connect a simulated airway to an inside of the simulated lungs so that air can flow without leakage, and connect the simulated airway to the mouth of the head in the mannequin of the upper half of the human body so that air can flow without leakage from the simulated airway. In this case, practice of cardiac massage can be performed in a state where an assist device such as “RESQPOD (registered trademark)”, medical device admission number: 22300BZX00315000, manufactured by U.S. Scientific Molding Corporation Ltd. is mounted to the mouth of the head in the mannequin of the upper half of the human body. This makes it possible to easily judge whether the performance of these assist devices in use is good or poor.

### —Virtual Blood—

Note in the present invention that, the virtual blood is not particularly limited and may be appropriately selected depending on the intended purpose so long as it is liquid. The viscosity of the virtual blood is preferably closer to that of actual blood, but suitable examples of the virtual blood include water.

The color of the liquid is not particularly limited and the liquid may be colorless or colored. In the case of coloring the liquid, the liquid colored red becomes closer to actual blood, making it possible to bring a real sense in practice of cardiac massage.

### —Use—

Practice of cardiac massage using the cardiac massage practice device of the present invention can be suitably performed by performing a cardiac massage step and a transferred virtual blood amount-measuring step.

The cardiac massage step is a step in which a person who practices cardiac massage repeats compressing at regular intervals a chest corresponding to a position of the simulated heart in the cardiac massage practice device of the present invention.

The transferred virtual blood amount-measuring step is a step of measuring an amount of virtual blood transferred from the cardiac massage practice device of the present invention per unit time of a time for which the cardiac massage step is performed.

A practice method of cardiac massage of performing the above steps is a cardiac massage practice method of the present invention. By performing each of the above steps, anyone who is not a skilled person or an expert can simply and easily judge whether skills of cardiac massage are good or poor by using as an indicator the amount of blood transferred during cardiac massage. Also, considering the fact that whether skills of cardiac massage are good or poor can be judged by using as an indicator the amount of blood transferred during cardiac massage, according to the present invention, whether the performance of assist devices used in cardiac massage is good or poor can also be judged similarly easily.

Suitable examples of the assist devices include “CARDIO PUMP” sold by IMI Corporation, Ltd., and “RESQPOD (registered trademark)”, medical device admission number: 22300BZX00315000, manufactured by U.S. Scientific Molding Corporation Ltd.

Here, several preferable embodiments of the present invention will be given.

<1> A cardiac massage practice device, including: a simulated heart; a simulated vein; a simulated artery; and a mannequin of an upper half of a human body,

wherein the simulated heart contracts from a stationary state to be deformable to a contracted state, and dilates from the stationary state to be deformable to a dilated state,

wherein the simulated vein is coupled to the simulated heart, and when the simulated heart dilates from the contracted state, the simulated vein transfers virtual blood to an inside of the simulated heart,

wherein the simulated artery is coupled to the simulated heart, and when the simulated heart contracts from the dilated state, the simulated artery transfers the virtual blood transferred to the inside of the simulated heart from the inside of the simulated heart to an outside of the simulated heart, and

wherein the mannequin of the upper half of the human body houses the simulated heart therein.

In the cardiac massage practice device according to <1> above, when the simulated heart dilates from the contracted state, the inside of the simulated heart turns into a state of negative pressure, so that the virtual blood is transferred to the inside of the simulated heart from the simulated vein coupled to the simulated heart. When the simulated heart contracts from the dilated state, the inside of the simulated heart turns into a state of positive pressure, so that the virtual blood in the inside of the simulated heart is transferred from the inside of the simulated heart to the outside of the simulated heart via the simulated artery coupled to the simulated heart. As a result, when cardiac massage is performed by regularly compressing the chest in the mannequin of the upper half of the human body of the cardiac massage practice device, the simulated heart repeatedly contracts and dilates in response to this massage, and the virtual blood is flown out to the outside of the simulated heart via the simulated artery. According to the cardiac massage practice device described in <1> above, anyone can easily confirm whether skills of cardiac massage are good or poor by confirming an amount of the virtual blood that has flown out to the outside of the simulated heart. In cardiac massage by the cardiopulmonary resuscitation, what is important is how much blood can be pumped out from the heart by the cardiac massage, and it should basically be evaluated that skills of cardiac massage are excellent when as much blood as possible has been able to be pumped out by the cardiac massage. The cardiac massage practice device described in <1> above enables such skills to be properly evaluated.

<2> The cardiac massage practice device described in <1> above,

wherein the simulated heart includes a hollow elastic body, a simulated mitral valve, and a simulated aortic valve,

wherein the hollow elastic body is deformable,

wherein the simulated mitral valve is provided in a coupling portion of the hollow elastic body to the simulated vein, and when the hollow elastic body dilates from the contracted state to deform to the dilated state, the simulated mitral valve opens and enables the virtual blood to be transferred from the simulated vein to an inside of the hollow elastic body and when the hollow elastic body contracts from the dilated state to deform to the contracted state, the simulated mitral valve closes and prevents backward flow of the virtual blood transferred to the inside of the hollow elastic body to the simulated vein, and

wherein the simulated aortic valve is provided in a coupling portion of the hollow elastic body to the simulated artery, and when the hollow elastic body contracts from the dilated state to deform to the contracted state, the simulated aortic valve opens and enables the virtual blood to be transferred from the inside of the hollow elastic body into the simulated artery and when the hollow elastic body dilates from the contracted state to deform to the dilated state, the simulated aortic valve closes and prevents backward flow of the virtual blood transferred to the simulated artery into the inside of the hollow elastic body.

In the cardiac massage practice device described in <2> above, when the hollow elastic body in the simulated heart dilates from the contracted state, the inside of the hollow elastic body turns into a state of negative pressure, so that the simulated mitral valve provided in a coupling portion of the hollow elastic body to the simulated vein opens and the simulated aortic valve provided in a coupling portion of the hollow elastic body to the simulated artery closes. In this state, the virtual blood is transferred to the inside of the hollow elastic body from the simulated vein coupled to the hollow elastic body. When the hollow elastic body in the simulated heart contracts from the dilated state, the inside of the hollow elastic body turns into a state of positive pressure, so that the simulated mitral valve closes and the simulated aortic valve opens. In this state, the virtual blood in the inside of the hollow elastic body is transferred from the inside of the hollow elastic body to the outside of the simulated heart via the simulated artery coupled to the hollow elastic body. As a result, when the cardiac massage is performed by regularly compressing the chest in the mannequin of the upper half of the human body of the cardiac massage practice device, the hollow elastic body repeatedly contracts and dilates in response to this massage, and the virtual blood is flown out to the outside of the simulated heart via the simulated artery. According to the cardiac massage practice device described in <2> above, anyone can easily confirm whether skills of cardiac massage are good or poor by confirming an amount of the virtual blood that has flown out to the outside of the simulated heart. In cardiac massage by the cardiopulmonary resuscitation, what is important is how much blood can be pumped out from the heart by the cardiac massage, and it should basically be evaluated that skills of cardiac massage are excellent when as much blood as possible has been able to be pumped out by the cardiac massage. The cardiac massage practice device described in <2> above enables such skills to be properly evaluated.

<3> The cardiac massage practice device described in <1> or <2> above,

wherein the simulated vein comprises a tubular structure with both ends open, and one of the ends of the tubular structure is coupled to the simulated heart so that the virtual blood can flow into the simulated heart and the other end of the tubular structure opposite to the one of the ends is extended to an outside of the mannequin of the upper half of the human body, and

wherein the simulated artery includes a tubular structure with both ends open, and one of the ends of the tubular structure is coupled to the simulated heart so that the virtual blood can flow out of the simulated heart and the other end of the tubular structure opposite to the one of the ends is extended to the outside of the mannequin of the upper half of the human body.

In the cardiac massage practice device described in <3> above, since each of the simulated vein and the simulated artery is a tubular structure with both ends open, the virtual blood can flow through the tubular structure. And, one end of the tubular structure of the simulated vein is coupled to the simulated heart and thus the virtual blood can pass through the tubular structure and flow into the simulated heart. The other end of the tubular structure of the simulated artery is extended to the outside of the mannequin of the upper half of the human body and thus, when practice of cardiac massage has been performed, it is possible to easily confirm an amount of the virtual blood that has flown out to the outside of the cardiac massage practice device and as a result anyone can easily confirm whether skills of cardiac massage are good or poor.

<4> The cardiac massage practice device described in any one of <1> to <3> above, wherein the simulated vein is coupled to a virtual blood container configured to contain the virtual blood.

In the cardiac massage practice device described in <4> above, the simulated vein is connected to the virtual blood container configured to contain the virtual blood and thus, when practice of cardiac massage is performed after the virtual blood container has been allowed to contain the virtual blood, it becomes easier to visually determine an amount of the virtual blood transferred by the cardiac massage.

<5> The cardiac massage practice device described in any one of <1> to <4> above,

wherein the simulated artery is connected to a liquid amount-measuring container capable of measuring an amount of the virtual blood transferred from the simulated heart.

In the cardiac massage practice device described in <5> above, the simulated artery is connected to the liquid amount-measuring container capable of measuring the amount of the virtual blood transferred and thus, in practice of cardiac massage, it becomes easier to visually determine how much of the virtual blood has been able to be transferred from the simulated heart per unit time of a time for which the practice of cardiac massage is performed.

<6> The cardiac massage practice device described in any one of <1> to <5> above,

wherein the mannequin of the upper half of the human body includes a simulated skin covering a surface thereof, and a simulated rib inside the simulated skin.

In the cardiac massage practice device described in <6> above, the mannequin of the upper half of the human body includes a simulated skin covering a surface thereof, and a simulated rib inside the simulated skin and thus, in practice of cardiac massage, a sense of chest compression can be obtained as a sense approximate to the performance in an actual human body. In addition, when a force of chest compression is too strong, the simulated rib will be broken to give similar effects to fracture of the ribs in an actual human body.

<7> The cardiac massage practice device described in <6> above,

wherein the simulated skin is a sheet-form object formed of a soft resin.

In the cardiac massage practice device described in <7> above, the simulated skin is a sheet-form object formed of a soft resin and thus, in practice of cardiac massage, the simulated skin of the mannequin of the upper half of the human body will not be torn, and a person can perform the practice while obtaining a sense close to the actual skin.

<8> The cardiac massage practice device described in <6> or <7>,

wherein the simulated rib is a plate-form object formed of a hard resin.

In the cardiac massage practice device described in <8> above, the simulated rib is a plate-form object formed of a hard resin and thus, in practice of cardiac massage, when a force of chest compression is too strong, the simulated rib will be broken to give similar effects to fracture of the ribs in an actual human body.

<9> The cardiac massage practice device described in any one of <6> to <8> above,

wherein the simulated skin and the simulated rib are transparent.

In the cardiac massage practice device described in <9> above, the simulated skin and the simulated rib are transparent and thus the simulated heart can be visually observed and, in practice of cardiac massage, movements of the simulated heart can be easily visually confirmed.

<10> The cardiac massage practice device described any one of <1> to <9> above, wherein the virtual blood is liquid.

In the cardiac massage practice device described in <10> above, the virtual blood is liquid and thus, in practice of cardiac massage, the virtual blood is transferred from the simulated vein to the simulated heart and then from the simulated heart to the simulated artery, so that blood flow in an actual human body is realized.

<11> A cardiac massage practice method of performing cardiac massage using a cardiac massage practice device which is formed to have a shape of a mannequin simulating an upper half of a human body, the method including:

a cardiac massage step of compressing at regular intervals a surface of a chest corresponding to a position of a heart in the cardiac massage practice device, and

a transferred virtual blood amount-measuring step of measuring an amount of virtual blood transferred from the cardiac massage practice device per unit time of a time for which the cardiac massage step is performed,

wherein the cardiac massage practice device is the cardiac massage practice device described in any one of <1> to <9> above.

In the cardiac massage practice method described in <11> above, the surface of the chest corresponding to the position of the heart in the cardiac massage practice device is compressed at regular intervals in the cardiac massage step. Here, when the simulated heart dilates from the contracted state, the inside of the simulated heart turns into a state of negative pressure, so that the virtual blood is transferred to the inside of the simulated heart from the simulated vein coupled to the simulated heart. When the simulated heart contracts from the dilated state, the inside of the simulated heart turns into a state of positive pressure, so that the virtual blood in the inside of the simulated heart is transferred from the inside of the simulated heart to the outside of the simulated heart via the simulated artery coupled to the simulated heart. As a result, when cardiac massage is performed by regularly compressing the chest in the mannequin of the upper half of the human body of the cardiac massage practice device, the simulated heart repeatedly contracts and dilates in response to this massage, and the virtual blood is flown out to the outside of the simulated heart via the simulated artery. In the transferred virtual blood amount-measuring step, measured is the amount of the virtual blood transferred from the cardiac massage practice device to the outside thereof per unit time of a time for which the cardiac massage step is performed. Anyone can easily confirm whether skills of cardiac massage are good or poor by confirming the amount of the virtual blood measured. In cardiac massage by the cardiopulmonary resuscitation, what is important is how much blood can be pumped out from the heart by the cardiac massage, and it should basically be evaluated that skills of cardiac massage are excellent when as much blood as possible has been able to be pumped out by the cardiac massage. The cardiac massage practice method described in <11> above enables such skills to be properly evaluated.

### EXAMPLES

Referring now to the drawings, one example of the present invention will be explained; however, the present invention should not be limited to this example. Note that, the symbols such as “1” each mean the same across the drawings.

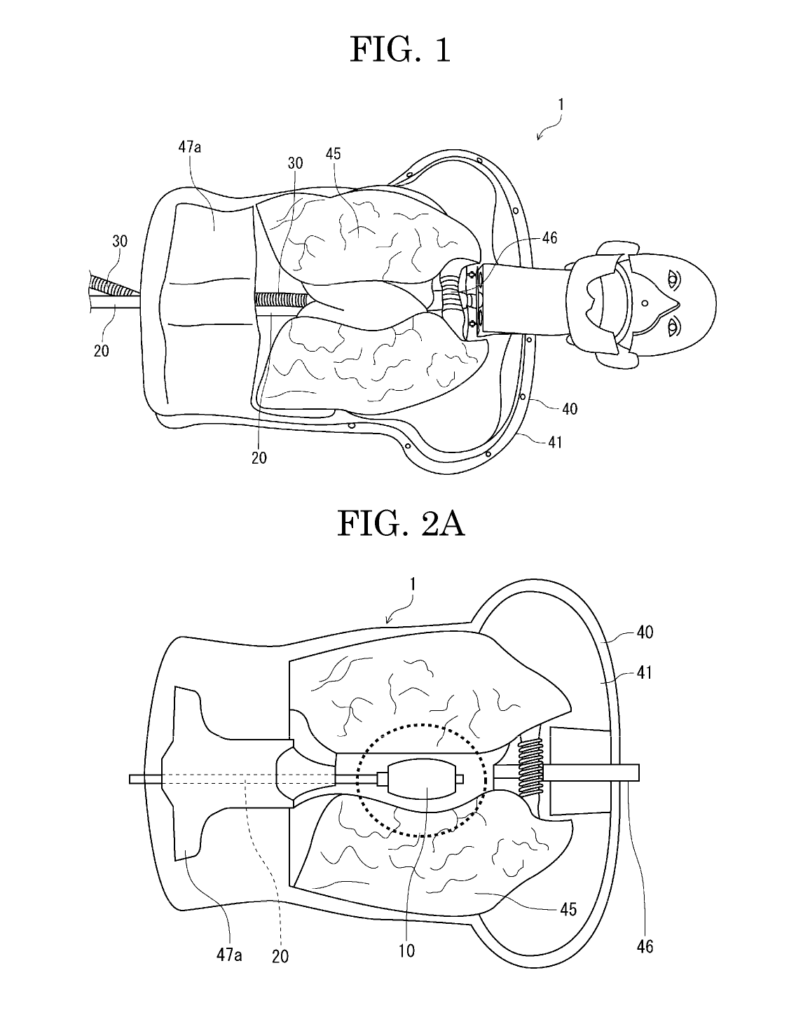

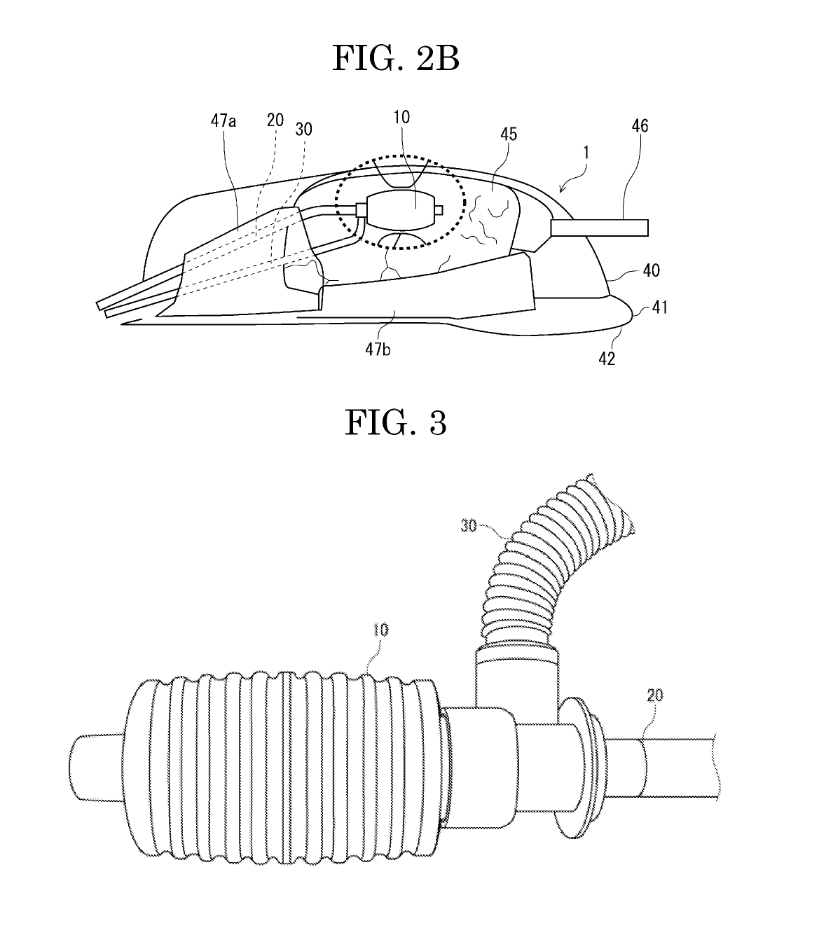

FIG. 1 is a schematic plan view of one example of the cardiac massage practice device of the present invention. FIG. 2A illustrates the cardiac massage practice device of FIG. 1 with the head removed, and is a schematic plan view for explaining arrangement of the simulated heart, the simulated vein and the simulated artery. FIG. 2B is a schematic side view illustrating the cardiac massage practice device of FIG. 2A from a side of the cardiac massage practice device.

In the cardiac massage practice device 1 illustrated in FIG. 1 and FIGS. 2A and 2B, a simulated heart 10 is embedded in a chest of a mannequin 40 of an upper half of a human body. In the mannequin 40 of the upper half of the human body, its front face portion where the chest is present has a shape simulating a human body, while its back face portion is a flat plate. In an inner space of the mannequin 40 of the upper half of the human body, a back face base 47b is disposed at a side of the back thereof; i.e., on the flat plate, and also a lower abdomen base 47a is disposed at a side of the lower abdomen thereof. In addition, a simulated heart 10 is disposed in a substantially center portion on the back face base 47b, and simulated lungs 45 are disposed in both sides of the simulated heart. The simulated lungs 45 are formed of a silicone resin, and the simulated lungs 45 enable deformation of contraction or dilation similar to the actual lungs and are designed upon this deformation so that air can flow into or out of the simulated lungs 45. And, a simulated airway is connected to the simulated lungs 45, and the simulated airway 46 is also connected to the mouth of the head in the mannequin 40 of the upper half of the human body. In this configuration, when practice of cardiac massage is performed by compressing the chest of the mannequin 40 of the upper half of the human body, air enters the mouth, passes through the simulated airway, and flows into the inner spaces of the simulated lungs 45; and the air exits from the inner spaces of the simulated lungs 45, passes through the simulated airway 46, and flows out from the mouth to the outside.

The simulated rib 42 is fixed on the flat plate in a stacked state at the side of the back face portion in the mannequin 40 of the upper half of the human body. The simulated rib 42 is disposed such that it is curved from the back side to the front side of the mannequin 40 of the upper half of the human body at a side of the lower abdomen thereof so as to cover the vicinity of the chest of the mannequin 40 of the upper half of the human body. As a result, the simulated rib 42 is disposed over the surfaces of the simulated lungs 45 so as to cover the simulated lungs 45. The simulated rib 42 is a structure formed by curving a plate of a thin layer of hard polystylene so as to have the above-described curved shape, and is colorless and transparent. Also, a simulated skin 41 is disposed so as to cover the entire surface of the mannequin 40 of the upper half of the human body. In this Example, the simulated skin 41 is formed as a sheet of a thin layer of soft polyvinyl chloride, and is fixed on the flat plate at the side of the back of the mannequin 40 of the upper half of the human body. The mannequin 40 of the upper half of the human body is formed so as to have elasticity as a whole, and is designed to cause similar deformation to an actual human body when its chest is compressed.

A simulated vein 20 and a simulated artery 30 are coupled to the simulated heart 10. The simulated vein 20 and the simulated artery 30 are extended in a direction of the lower abdomen, and one end of each of the simulated vein 20 and the simulated artery 30 is coupled to the simulated heart 10, and the other end opposite to the one end thereof is extended to go beyond an end of the mannequin 40 of the upper half of the human body at a side of the lower abdomen, and is exposed.

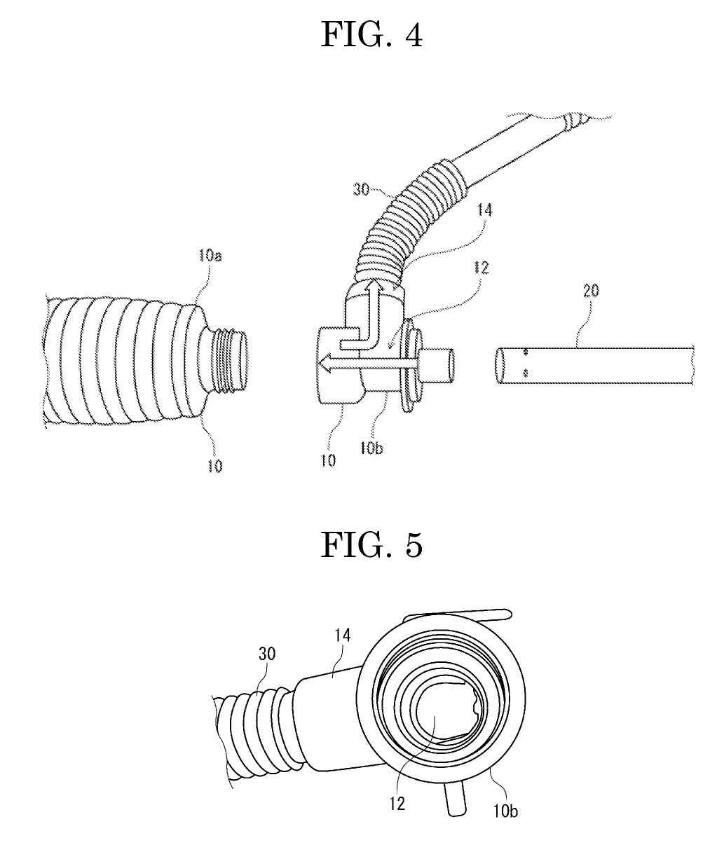

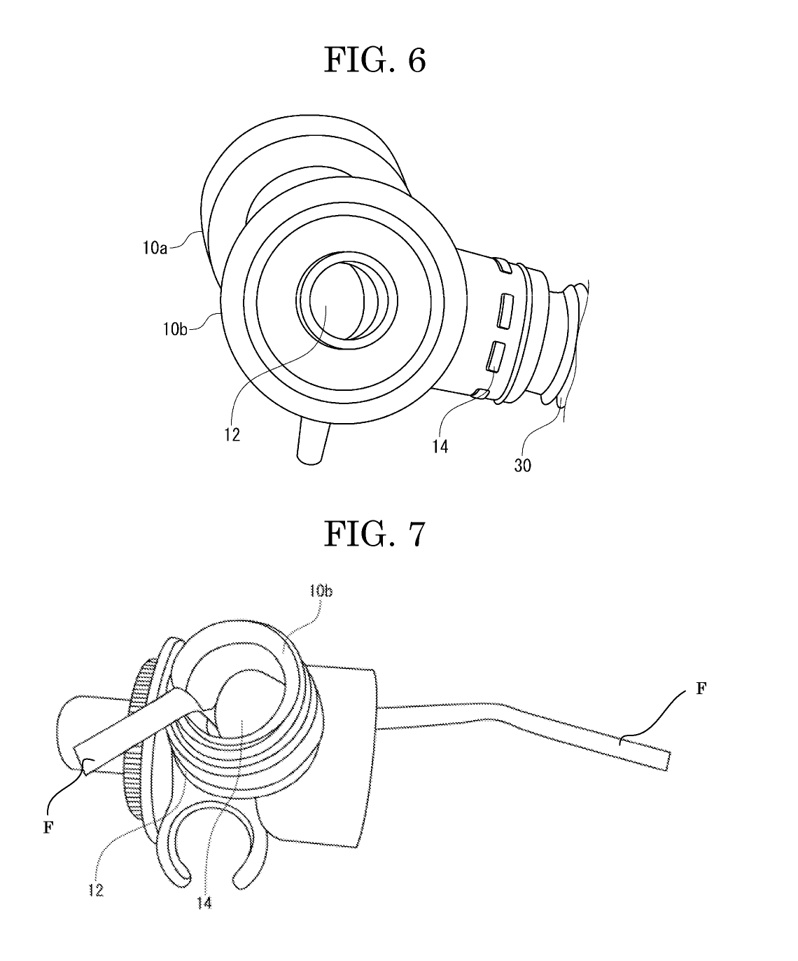

Here, referring to FIGS. 3 to 7, the structure and functions of the simulated heart 10 will be explained. FIG. 3 is a schematic explanatory view of one example of the simulated heart in the present invention. FIG. 4 is a schematic explanatory view illustrating a state where the simulated heart of FIG. 3 is disassembled into a hollow elastic body and a valve-containing member. FIG. 5 is a schematic explanatory view illustrating a simulated mitral valve disposed in the valve-containing member of FIG. 4 from a side of the hollow elastic body (from the inside of the simulated heart). FIG. 6 is a schematic explanatory view illustrating a simulated mitral valve disposed in the valve-containing member of FIG. 4 from a side where the simulated vein is to be coupled (from the inside of the simulated vein). FIG. 7 is a schematic explanatory view illustrating a simulated aortic valve disposed in the valve-containing member of FIG. 4 from a side where the simulated artery is to be coupled (from the inside of the simulated artery). A line denoted by “F” in FIG. 7 indicates flow of the virtual blood. As is clear from FIG. 7, the virtual blood flows via the simulated aortic valve 14 to the simulated artery 30. In FIG. 7, the simulated aortic valve 14 is partially opened.

The simulated heart 10 has a hollow elastic body 10a and a valve-containing member 10b.

The hollow elastic body 10a is a hollow structure formed of polypropylene and is formed to have a substantially cylindrical shape. The hollow elastic body 10a has elasticity with which it contracts or dilates to be deformable in both radial and axial directions thereof.

The valve-containing member 10b is formed of hard polyester, and is screwed in the hollow elastic body 10a so that no leakage of liquid occurs and the liquid can flow via the valve-containing member 10b into or out of the hollow elastic body 10a. The valve-containing member 10b has a coupling portion to the simulated vein 20, and is coupled to the simulated vein 20 so that no leakage of liquid occurs and the liquid can flow via the valve-containing member 10b from the simulated vein 20. The valve-containing member 10b also has a coupling portion to the simulated artery 30, and is coupled to the simulated artery 30 so that no leakage of liquid occurs and the liquid can flow via the valve-containing member 10b into the simulated artery 30. In the valve-containing member 10b, a simulated mitral valve 12 is disposed in the coupling portion to the simulated vein 20, and a simulated aortic valve 14 is disposed in the coupling portion to the simulated artery 30. Each of the simulated mitral valve 12 and the simulated aortic valve 14 is formed of polyester.

Next, the operation of the simulated heart 10 will be explained. When the hollow elastic body 10a in the simulated heart 10 dilates from the contracted state, the inside of the hollow elastic body 10a turns into a state of negative pressure, so that the simulated mitral valve 12 provided in the coupling portion of the hollow elastic body 10a to the simulated vein 20 opens and the simulated aortic valve 14 provided in the coupling portion of the hollow elastic body 10a to the simulated artery 30 closes. In this state, the virtual blood is transferred to the inside of the hollow elastic body 10a from the simulated vein 20 coupled to the hollow elastic body 10a. In this Example, the exposed end of the simulated vein 20, which is exposed to the outside of the mannequin 40 of the upper half of the human body, is attached to a bucket serving as the virtual blood container so that water in the bucket serving as the virtual blood can flow into the simulated vein 20. The virtual blood is aspirated from the bucket to flow into the simulated vein 20, moves through the simulated vein 20, and is aspirated to flow into the hollow elastic body 10a via the simulated mitral valve 12 in the simulated heart 10. In the hollow elastic body 10a, the simulated aortic valve 14 is closed and thus the virtual blood that has flown into the hollow elastic body 10a does not flow out into the simulated artery 30.

When the hollow elastic body 10a in the simulated heart 10 contracts from the dilated state, the inside of the hollow elastic body 10a turns into a state of positive pressure, so that the simulated mitral valve 12 closes and the simulated aortic valve 14 opens. In this state, the virtual blood in the hollow elastic body 10a is pushed out from the hollow elastic body 10a to flow out via the simulated aortic valve 14 into the simulated artery 30 coupled to the hollow elastic body 10a. In this Example, the exposed end of the simulated artery 30, which is exposed to the outside of the mannequin 40 of the upper half of the human body, is attached to a scaled bucket for measuring volume serving as the liquid amount-measuring container, and the virtual blood pushed out to flow out into the simulated artery 30 is transferred from the simulated artery 30 into the bucket.

In this configuration, when practice of cardiac massage is performed by regularly compressing the chest in the mannequin 40 of the upper half of the human body of the cardiac massage practice device 1, the hollow elastic body 10a repeatedly contracts and dilates in response to this massage, so that the virtual blood is transferred via the simulated artery 30 to the scaled bucket for measuring volume serving as the liquid amount-measuring container.

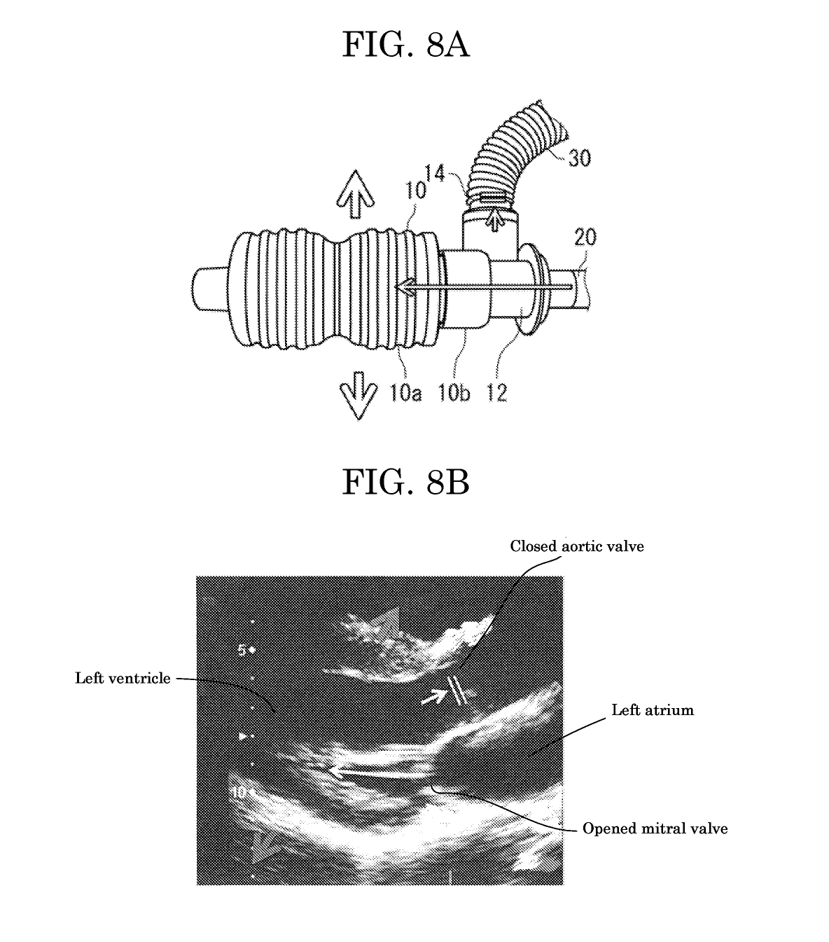

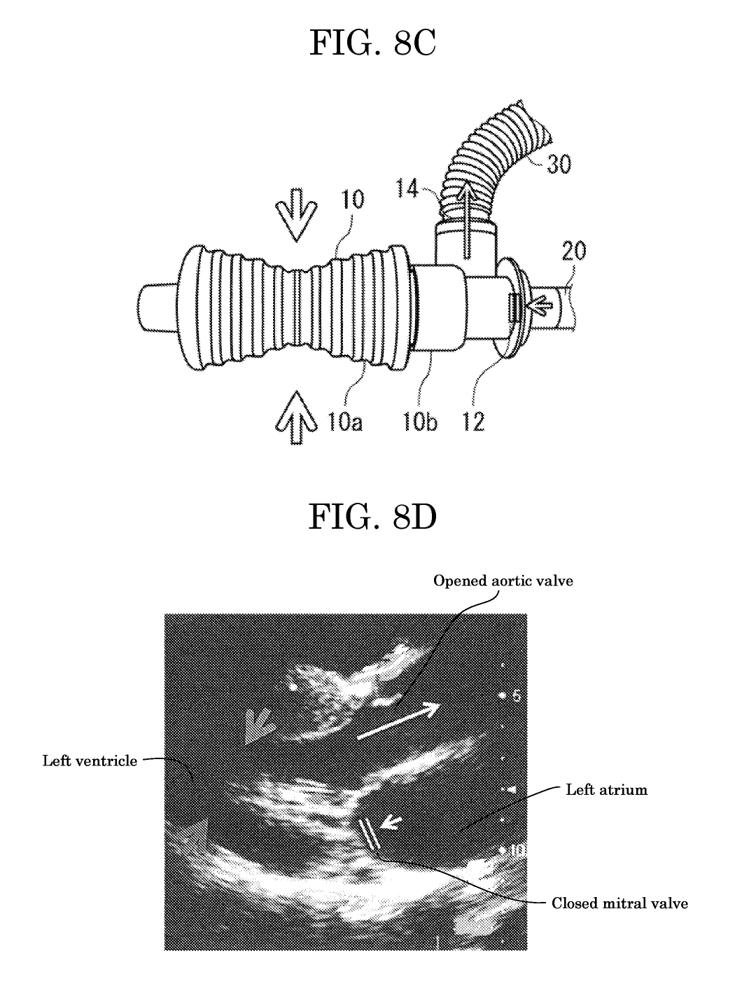

Here, referring to FIGS. 8A to 8D, it will be explained that movements of the simulated mitral valve 12 and the simulated aortic valve 14 in the simulated heart 10 and flow of the virtual blood are the same as movements of the mitral valve and the aortic valve in the actual heart of a human and flow of blood.

FIG. 8A is a schematic explanatory view for explaining movements of the simulated mitral valve and the simulated aortic valve and flow of virtual blood when the simulated heart is in diastole. FIG. 8B is an echocardiogram corresponding to FIG. 8A for explaining movements of the mitral valve and the aortic valve and flow of blood in the actual heart in diastole. As illustrated in FIG. 8A, when the simulated heart 10 is in diastole during cardiac massage, the simulated mitral valve 12 opens and the virtual blood flows out from the simulated vein 20 into the simulated heart 10. Since the simulated aortic valve 14 closes, the virtual blood that has flown into the simulated heart 10 is not transferred from the simulated heart 10 into the simulated artery 30 via the simulated aortic valve 14. When looking at this in the actual heart, as illustrated in FIG. 8B, the mitral valve is opened in diastole of the heart, so that blood flows into the left ventricle. The blood that has flown into the left ventricle does not flow out into the aorta since the aortic valve is closed. Hence, the movements of the actual left ventricle in diastole are the same as the movements in the simulated heart 10 in the present invention.

FIG. 8C is a schematic explanatory view for explaining movements of the simulated mitral valve and the simulated aortic valve and flow of virtual blood when the simulated heart is in systole. FIG. 8D is an echocardiogram corresponding to FIG. 8C for explaining movements of the mitral valve and the aortic valve and flow of blood in the actual heart in systole. As illustrated in FIG. 8C, when the simulated heart 10 is in systole during cardiac massage, the simulated aortic valve 14 opens and the virtual blood flows out from the simulated heart 10 into the simulated artery 30. Since the simulated mitral valve 12 is closed, the virtual blood in the simulated heart 10 is not transferred from the simulated heart 10 into the simulated vein 20 via the simulated mitral valve 12; i.e., the virtual blood in the simulated heart 10 does not flow backward. When looking at this in the actual heart, as illustrated in FIG. 8D, the aortic valve is opened in systole of the left ventricle, so that blood flows out to the aorta. Since the mitral valve is closed, blood is not transferred into the left atrium; i.e., the blood does not flow backward. Hence, the movements of the actual left ventricle in systole are the same as the movements in the simulated heart 10 in the present invention. Note that, the number of chambers (spaces) in the simulated heart 10 in this Example is “1”. The actual heart has “4” chambers (spaces) of the right atrium, the right ventricle, the left atrium, and the left ventricle. These 4 chambers (spaces) are partitioned by valves but are in communication with each other so that blood can flow, and thus these “4” chambers can be regarded as “1” chamber. In this case, this “1” chamber can be assumed to be the same as “left ventricle”, which is the most important in the heart and influences blood pressure in transferring blood to the whole body. The movement of this “left ventricle” and the amount of blood transferred by the “left ventricle” can be confirmed in practice of cardiac massage in this Example.

According to this cardiac massage practice device 1, anyone can easily confirm whether skills of cardiac massage are good or poor by confirming an amount of the virtual blood that has flown out or has been transferred into the scaled bucket for measuring volume serving as the liquid amount-measuring container. In cardiac massage by the cardiopulmonary resuscitation, what is important is how much blood can be pumped out from the heart by the cardiac massage, and it should basically be evaluated that skills of cardiac massage are excellent when as much blood as possible has been able to be pumped out by the cardiac massage. This cardiac massage practice device 1 enables such skills to be properly evaluated.

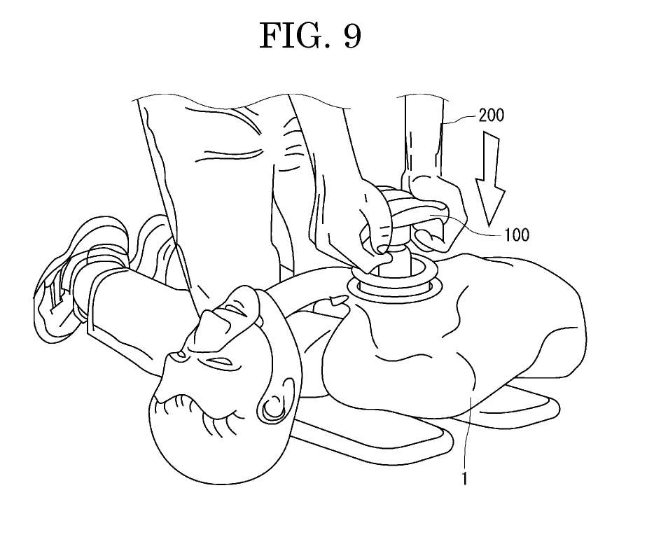

As a result, when practice of cardiac massage is performed further using commercially available assist devices used in cardiac massage such as “CARDIO PUMP” illustrated in FIG. 9 (sold by IMI Corporation, Ltd.), and “RESQPOD (registered trademark)” (manufactured by U.S. Scientific Molding Corporation Ltd., medical device admission number: 22300BZX00315000), anyone can also judge easily and visually whether the performance of these assist devices is good or poor by using an amount of the virtual blood as an indicator.

The cardiac massage practice device and the cardiac massage practice method of the present invention can be suitably utilized in practice for cardiac massage by the cardiopulmonary resuscitation, especially in practice by beginners rather than skilled people, and also can be suitably utilized for simple evaluation of performance of commercially available assist devices for cardiac massage in use.

The present invention can solve the above conventional problems and provide a cardiac massage practice device and a cardiac massage practice method, with which cardiac massage by the cardiopulmonary resuscitation can be realistically practiced in a state close to the actual state using a mannequin simulating a human body, anyone who is not an expert can easily and conveniently know the amount of blood that has been able to be transferred from the heart by cardiac massage, whether skills of cardiac massage are good or poor can be judged by using this amount of blood transferred as an indicator, and whether the performance of assist devices such as a manual pump in use is good or poor can also be judged properly and easily.

What is claimed is:

1. A cardiac massage practice device, comprising:
a simulated heart;
a simulated vein;
a simulated artery; and
a mannequin of an upper half of a human body,
wherein the simulated heart contracts from a stationary state to be deformable to a contracted state, and dilates from the stationary state to be deformable to a dilated state,
wherein the simulated vein is coupled to the simulated heart, and when the simulated heart dilates from the contracted state, the simulated vein transfers virtual blood to an inside of the simulated heart,
wherein the simulated artery is coupled to the simulated heart, and when the simulated heart contracts from the dilated state, the simulated artery transfers the virtual blood transferred to the inside of the simulated heart from the inside of the simulated heart to an outside of the simulated heart, and
wherein the mannequin of the upper half of the human body houses the simulated heart therein.

2. The cardiac massage practice device claimed in claim 1,
wherein the simulated heart comprises a hollow elastic body, a simulated mitral valve, and a simulated aortic valve,
wherein the hollow elastic body is deformable,
wherein the simulated mitral valve is provided in a coupling portion of the hollow elastic body to the simulated vein, and when the hollow elastic body dilates from the contracted state to deform to the dilated state, the simulated mitral valve opens and enables the virtual blood to be transferred from the simulated vein to an inside of the hollow elastic body and when the hollow elastic body contracts from the dilated state to deform to the contracted state, the simulated mitral valve closes and prevents backward flow of the virtual blood transferred to the inside of the hollow elastic body to the simulated vein, and
wherein the simulated aortic valve is provided in a coupling portion of the hollow elastic body to the simulated artery, and when the hollow elastic body contracts from the dilated state to deform to the contracted state, the simulated aortic valve opens and enables the virtual blood to be transferred from the inside of the hollow elastic body into the simulated artery and when the hollow elastic body dilates from the contracted state to deform to the dilated state, the simulated aortic valve closes and prevents backward flow of the virtual blood transferred to the simulated artery into the inside of the hollow elastic body.

3. The cardiac massage practice device claimed in claim 1,
wherein the simulated vein comprises a tubular structure with both ends open, and one of the ends of the tubular structure is coupled to the simulated heart so that the virtual blood can flow into the simulated heart and the other end of the tubular structure opposite to the one of the ends is extended to an outside of the mannequin of the upper half of the human body, and
wherein the simulated artery comprises a tubular structure with both ends open, and one of the ends of the tubular structure is coupled to the simulated heart so that the virtual blood can flow out of the simulated heart and the other end of the tubular structure opposite to the one of the ends is extended to the outside of the mannequin of the upper half of the human body.

4. The cardiac massage practice device claimed in claim 1,
wherein the simulated vein is connected to a virtual blood container configured to contain the virtual blood.

5. The cardiac massage practice device claimed in claim 1,
wherein the simulated artery is connected to a liquid amount-measuring container capable of measuring an amount of the virtual blood transferred from the simulated heart.

6. The cardiac massage practice device claimed in claim 1,
wherein the mannequin of the upper half of the human body comprises a simulated skin covering a surface thereof, and a simulated rib inside the simulated skin.

7. The cardiac massage practice device claimed in claim 6,
wherein the simulated skin is a sheet-form object formed of a soft resin.

8. The cardiac massage practice device claimed in claim 6,
wherein the simulated rib is a plate-form object formed of a hard resin.

9. The cardiac massage practice device claimed in claim 6,
wherein the simulated skin and the simulated rib are transparent.

10. The cardiac massage practice device claimed in claim 1,
wherein the virtual blood is liquid.

11. A cardiac massage practice method of performing cardiac massage using a cardiac massage practice device which is formed to have a shape of a mannequin simulating an upper half of a human body, the method comprising:
compressing at regular intervals a surface of a chest corresponding to a position of a heart in the cardiac massage practice device, and
measuring an amount of virtual blood transferred from the cardiac massage practice device per unit time of a time for which the compressing is performed,
wherein the cardiac massage practice device comprises:
a simulated heart;
a simulated vein;
a simulated artery; and
a mannequin of an upper half of a human body,
wherein the simulated heart contracts from a stationary state to be deformable to a contracted state, and dilates from the stationary state to be deformable to a dilated state,
wherein the simulated vein is coupled to the simulated heart, and when the simulated heart dilates from the contracted state, the simulated vein transfers virtual blood to an inside of the simulated heart,
wherein the simulated artery is coupled to the simulated heart, and when the simulated heart contracts from the dilated state, the simulated artery transfers the virtual blood transferred to the inside of the simulated heart from the inside of the simulated heart to an outside of the simulated heart, and
wherein the mannequin of the upper half of the human body houses the simulated heart therein.

12. The cardiac massage practice method claimed in claim 11,
wherein the simulated heart comprises a hollow elastic body, a simulated mitral valve, and a simulated aortic valve,
wherein the hollow elastic body is deformable,
wherein the simulated mitral valve is provided in a coupling portion of the hollow elastic body to the simulated vein, and when the hollow elastic body dilates from the contracted state to deform to the dilated state, the simulated mitral valve opens and enables the virtual blood to be transferred from the simulated vein to an inside of the hollow elastic body and when the hollow elastic body contracts from the dilated state to deform to the contracted state, the simulated mitral valve closes and prevents backward flow of the virtual blood transferred to the inside of the hollow elastic body to the simulated vein, and
wherein the simulated aortic valve is provided in a coupling portion of the hollow elastic body to the simulated artery, and when the hollow elastic body contracts from the dilated state to deform to the contracted state, the simulated aortic valve opens and enables the virtual blood to be transferred from the inside of the hollow elastic body into the simulated artery and when the hollow elastic body dilates from the contracted state to deform to the dilated state, the simulated aortic valve closes and prevents backward flow of the virtual blood transferred to the simulated artery into the inside of the hollow elastic body.

13. The cardiac massage practice method claimed in claim 11,
wherein the simulated vein comprises a tubular structure with both ends open, and one of the ends of the tubular structure is coupled to the simulated heart so that the virtual blood can flow into the simulated heart and the other end of the tubular structure opposite to the one of the ends is extended to the outside of the mannequin of the upper half of the human body, and
wherein the simulated artery comprises a tubular structure with both ends open, and one of the ends of the tubular structure is coupled to the simulated heart so that the virtual blood can flow out of the simulated heart and the other end of the tubular structure opposite to the one of the ends is extended to the outside of the mannequin of the upper half of the human body.

14. The cardiac massage practice method claimed in claim 11,
wherein the simulated vein is connected to a virtual blood container configured to contain the virtual blood.

15. The cardiac massage practice method claimed in claim 11,
wherein the simulated artery is connected to a liquid amount-measuring container capable of measuring an amount of the virtual blood transferred from the simulated heart.

16. The cardiac massage practice method claimed in claim 11,
wherein the mannequin of the upper half of the human body comprises a simulated skin covering a surface thereof, and a simulated rib inside the simulated skin.

17. The cardiac massage practice method claimed in claim 16,
wherein the simulated skin is a sheet-form object formed of a soft resin.

18. The cardiac massage practice method claimed in claim 16,
wherein the simulated rib is a plate-form object formed of a hard resin.

19. The cardiac massage practice method claimed in claim 16,
wherein the simulated skin and the simulated rib are transparent.

20. The cardiac massage practice method claimed in claim 11,
wherein the virtual blood is liquid.
